(19) United States
(12) Patent Application Publication
(10) Pub. No.: US 2010/0174593 A1
(43) Pub. Date: Jul. 8, 2010

(54) ONLINE SIMULATIONS AND NETWORK APPLICATIONS

(75) Inventors: Christopher Udo Cao, Austin, TX (US); Paul Warner, Austin, TX (US)

Correspondence Address: MAYER & WILLIAMS PC, 251 NORTH AVE. WEST, 2ND FLOOR, WESTFIELD, NJ, 07090, US

(73) Assignee: SONY ONLINE ENTERTAINMENT LLC, San Diego, CA (US)

(21) Appl. No.: 12/633,635

(22) Filed: Dec. 8, 2009

Related U.S. Application Data
(60) Provisional application No. 61/120,727, filed on Dec. 8, 2008.

(51) Int. Cl. G06Q 30/00; A63F 9/24; G06Q 10/00; G06Q 50/00

(52) U.S. Cl. 705/14.12; 463/42; 705/14.41

(57) ABSTRACT

Systems and methods are provided that involve a player to a significant degree with an advertisement and its accompanying product or service. One setting of the system and method may be a network application that is adjunct to an online simulation such as an MMO game. The system and method may be implemented in either or both, or in video games that are embodied in just one of these. The system and method provide a convenient way to tie advertising to game content. By use of advertisements, the user (through the player character) can become aware of and can access in-game items, player character attribute modifications, and rewards. Such advertisements may be banner advertisements or any other type of advertising. By taking advantage of the offers presented in the advertisements, a user of the network application may obtain items for their own use or for that of a corresponding MMO character.

### CROSS-REFERENCE TO RELATED APPLICATIONS

This non-provisional patent application claims the benefit of U.S. Provisional Patent Application Ser. No. 61/120,727, filed on Dec. 8, 2008, and entitled “WEB-BASED APPLICATION ADJUNCT TO ONLINE SIMULATION”, assigned to the assignee of the present invention and herein incorporated by reference in its entirety.

### BACKGROUND OF THE INVENTION

Massively multiplayer online (“MMO”) games enjoy tremendous popularity, with some games numbering players in the hundreds of thousands or even millions. Besides their large numbers of players, MMO players can come from many different demographics. Accordingly, in-game advertising has arisen as a means of advertising products to these many users.

In-game advertising can take many forms, e.g., static advertising such as virtual billboards, or alternatively, dynamic advertising with content that can be modified on-the-fly by an advertiser. In some cases, the advertisement may be for direct product sales. For example, the game Everquest 2®, available from Sony Online Entertainment LLC, included an in-game command line function whereby a player could order food from Pizza Hut®. In general, however, in-game advertising is a passive display of a product or service, with accompanying text, to a player. As a consequence, players may see the advertisement as part of a background but may not remember details of the same.

### SUMMARY OF THE INVENTION

Systems and methods are provided that involve a player to a significant degree with an advertisement and its accompanying product or service (hereinafter occasionally referred to as just “product”). One setting of the system and method may be a network application that is adjunct to an online simulation such as an MMO game. The system and method may be implemented in either or both, or in video games that are embodied in just one of these.

The system and method provide a convenient way to tie advertising to game content. By use of advertisements, e.g., in the network application, the user (through the player character) can become aware of and can access in-game items, player character attribute modifications, and rewards. Such advertisements may be banner advertisements or any other type of advertising. The same may be placed within the context of textual or lower-fidelity portions of the network application. By taking advantage of the offers presented in the advertisements, a user of the network application may obtain items for their own use or for that of a corresponding MMO character. While implementations are discussed here primarily for network applications such as web applications, it will be clear that the same may well apply to the MMO context. In some such implementations, both may be employed in a synergistic fashion.

Items of equipment associated with a player character may also provide opportunities for advertisements and marketing revenue. For example, an item may be an avatar of an existing consumer item, or may be related to an existing consumer item, and by using the consumer item in-game, the user may become interested in the consumer item outside-of-game. In this way, in-game advertising may be accomplished in a highly interactive and interesting fashion. Such items may have expiration dates in order to require the character to obtain (and thus be introduced to) new items periodically.

The user may obtain such items in numerous ways, e.g., by clicking on a banner advertisement or the like. By clicking through to and viewing the advertisement, the user may obtain the item in their player character's inventory. In another way, by clicking on or selecting an item in another player character's inventory or equipped items, the user can view the corresponding advertisement and then click through to receive their own item.

Certain equipment may be particularly suited for use in an MMO setting, while other equipment is particularly suited for use in the network application. For example, in a superhero game, “civilian” clothes may be for use in a web-based “secret identity” network application, while superhero costumes are for use in the superhero MMO. In another implementation, registration of a code from a physical product may provide an in-game benefit as well. For example, if a user purchases a particular mobile phone, the character may be able to access an in-game item representing the same or a related phone.

In one aspect, the invention is directed towards a computer-readable medium, having instructions for causing a processor in an electronic device to perform a method of advertising a product or service, the method including steps of: displaying an advertisement for a product or service in a video game, the video game including one or more player characters operable by one or more users, receiving a response from a user about the advertisement, in response to the received response, modifying an attribute of a player character associated with the user, the modification relating to the advertisement, or allowing the player character to access a virtual item relating to the advertisement.

Implementations of the medium may include one or more of the following. The video game may be a network application, may be associated with an online multiplayer game, and may be a web application. The video game may run on a personal computer, a game console, a mobile phone, or a personal digital assistant. The advertisement may be a banner advertisement, an in-game advertisement, a clickable item of a player character's inventory, a clickable item of a player character's non-inventory items, or an advertisement displayed in an in-game store or kiosk. The virtual item may be transferred from the network application to a player character in the online multiplayer game. The advertisement may include an avatar of the product, and may be textual or low-fidelity. The attribute or item may expire after a predetermined period of time or after a predetermined amount of use. A time required for a player character to complete a task or quest may be at least partially related to the item or attribute.

In another aspect, the invention is directed towards a computer-readable medium, having instructions for causing a processor in an electronic device to perform a method of advertising a product or service, the method including steps of displaying an advertisement for a product or service, receiving a response from a player about the advertisement, in response to the receiving, modifying an attribute of a player character in a video game or allowing a player character to access a virtual item in a video game, the video game including one or more player characters operable by one or more users. In one implementation, the product or service may be related to the attribute or item.

In yet another aspect, the invention is directed towards a computer-readable medium, having instructions for causing a processor in an electronic device to perform a method of advertising a product or service, the method including steps of displaying an entry form on a user interface for a video game, receiving a code entered by a user in the entry form, in response to the received code, modifying an attribute of a player character in a video game or allowing a player character to access a virtual item in a video game, the video game including one or more player characters operable by one or more users.

Implementations of the medium may include one or more of the following. The code may be associated with the user purchase of a product or service, and the product or service may be related to the attribute or item.

In a further aspect, the invention is directed towards a method for transforming data, including receiving a user activation of an advertisement, upon receiving the user activation, transforming a data structure corresponding to the advertisement into a data structure corresponding to an item associated with the advertisement, the item accessible by a player character in a video game.

In another aspect, the invention is directed towards a system for providing an item to a player character associated with a user of a multiplayer game implemented on a network application server, including an advertisement receiver module to receive an advertisement from an advertising server, a user interface module to display the advertisement, an advertisement item provider module to, upon user activation of the advertisement, make accessible a corresponding item to a player character associated with the user.

In another aspect, the invention is directed towards a system for providing an item to a player character associated with a user of a multiplayer game implemented on a network application server, including a user interface module to display an item or attribute modification on a first player character, an advertisement item provider module to, upon user activation of the item or attribute modification, make accessible a corresponding item or attribute modification to a second player character, the second player character associated with the user. In one implementation, the user interface module may be further configured to, upon the user activation, display an advertisement corresponding to the item or attribute modification.

Advantages of the invention may include one or more of the following. Advertisements in a network application may be tied to gameplay in the network application or in an adjunct application, such as an MMO. By clicking on an advertisement, a user may obtain a corresponding item for use in the MMO or in the network application or both. In this way, the system and method may involve the user to a high degree in responding to advertising, and thus the advertisement is made highly effective. In the game itself, the use of certain items obtained from advertisements may allow users to complete certain tasks in a more rapid, thorough, or immersive fashion.

The setting of the system and method may be a network application that serves as an adjunct to an online simulation, affording significant additional and complementary functionality. In one implementation, the network application is web-based and enables a user to control aspects of a character in a simulated world, e.g., an MMO game. As an example, if the MMO were a superhero MMO, the network application may be a secret identity system which allows a user to control an “alter ego” of a superhero. In such a case, the network application allows a player to explore and control their character in a different way, e.g., performing acts in the life of the character that are complementary to those performed in the MMO. Such acts can include not only trading, crafting, buying, and selling, but also taking part in quests and performing tasks.

Other advantages inure from the use of a linked network application and online simulation. For example, in video games, completing a quest or task or performing a trade or crafting skill are common acts. The same is the basis for many kinds of advancement. In prior games, tasks were highly linear, such as “defeat a number x of opponents y”. While the task may be completed in numerous ways, there was no inherent variability in the task. Systems and methods disclosed here provide such variability. First, the player may choose how certain steps of the task are completed, e.g., “take a short cut” versus “take the long road”. Second, a degree of randomness can be inserted into task completion, e.g., taking the “short cut” noted above may fail from the standpoint of the character, potentially causing an even longer time to complete the task than if the player took the “long road”. Each player may receive only a set number of hours per day, e.g., eight hours, to perform tasks, and thus economizing becomes a game dynamic.

In one specific implementation, a task is divided into three steps, and the player may choose how each step is performed. By selecting different options for each step, the player controls the total amount of time the task will take to complete. Therefore, players may advantageously budget their activities and choose what they want their character to accomplish in a given day. As time is consumed performing the steps of the task, the allotted time may be seen to count down on the clock. Typically, the time is accelerated, but a “real time” countdown may also be implemented. As time counts down, the player may view a scrolling list of actions that are occurring during performance of the step (and ultimately, task), these actions depending on the steps chosen by the player. The equipment carried by a player character may allow tasks, or steps within tasks, to take less time, thus allowing more tasks to be accommodated in the daily allotment. For example, if a character has a fast mode of transportation, travel may take less time. If a character has an advanced mobile phone, communications may take less time. A degree of randomness may be included, where certain step choices, thought to have one outcome, may instead fail and result in a different outcome. A player may be allotted a limited amount of time each day for task completion; accordingly, planning and step choices are important and interesting for the player.

Other advantages from the use of a linked network application and online simulation may be the context of social networking. For example, the network application described above may afford significant social networking functionality, including contact lists, friend lists, a messaging capability, a profile, and blogs. When adjunct to an online simulation such as an MMO, the network application may act as a social network for the player character, particularly with regard to that part of the player character related to the network application, e.g., the secret identity in the case of a super hero MMO. While web-based role-playing games are known, these generally do not provide significant social networking features, instead following standard game conventions. In the same way, conventional MMOs generally provide little social networking.

In a game environment, social networking conventions may be leveraged to not only provide information about player characters but the social network may provide a forum to play an adjunct game, i.e., one running in parallel with the MMO. As the network application functions with standard social networking conventions, it has a low barrier to entry and is easily accessible even by newcomers to online gaming. It may be especially desirable to users because it affords a high degree of socialization. The social networking features may be accessed even by those with no MMO game client or those to whom the MMO functionality is incidental.

Other social networking features may be used, e.g., in a super hero setting players can view other players' secret identities and/or super hero characters, leader boards, and any other exposed information via the network application. A news feed about other characters may be displayed. A separate site may be provided where a player can view all of their MMO characters and associated secret identities in a single webpage. From within the network application, a player may view the characters, e.g., in a “paper doll” format.

Broadly, the network application can provide social networking functionality for any network, including a home network. In so doing, users can post information about themselves and about networked equipment (using appropriate security precautions). In this way, users may communicate with other users, share content, and control network components.

In another social networking aspect, systems and methods are described that can provide goods or attributes (or information) from an online simulation to a separate network application or vice-versa. In this context, attributes or items attained or obtained in the MMO may be transferred or transformed for use in the network application, and vice-versa. More generally, in a related social networking aspect, systems and methods are described that employ the network application to extend community and character features of the online simulation. That is, while prior games have displayed in-game information on the web, these systems generally do not allow the transfer of items, information, content, and communications through a central source.

For example, an online simulation such as an MMO may extend community and character features to a network application such that players may access their own and others' game information from any network-accessible client. In this way, a player may access a character that exists within the network application, within the MMO, or both. Besides accessing, the network application may allow a player to modify or play a character, such as by using the character to complete tasks or quests, or by performing crafting or trade skills. If character or item data is modified in the network application, such as by crafting or task performance, the modified data is saved and retrieved (in its modified form) the next time the player logs onto the MMO or the network application.

The invention may be embodied in a number of ways. For example, calculations involving data from the MMO may be extracted and displayed or otherwise employed in the network application, e.g., to provide a summary version of MMO character statistics or conversely to provide a breakdown of data that is only summarized in the MMO. Various other transformations may be provided. The network application may portray data that may be less appropriate in the MMO; for example, voluminous information about equipment, guilds, crafting, and other features may be provided in the network application, saving the MMO for more active, or interactive, data presentations, e.g., battles, fighting, or the like. Generally, the information presented in the network application may be cumulative, complementary, transformative, mapped, or unrelated to the information presented in the online simulation.

The system is broader than just game applications. For example, a home network provides an environment similar to an MMO and the network application may allow a user to access and modify components in the home network from any network-accessible location. In this case, the user interface may display an avatar which can be manipulated in a visual representation of the home network to access and modify network components.

### BRIEF DESCRIPTION OF THE DRAWINGS

FIG. 1 illustrates a schematic diagram of a user interface of a multiplayer game.

FIG. 2 illustrates two schematic diagrams of respective user interfaces of a multiplayer game, one for an online MMO and another for a network application adjunct to the MMO.

FIG. 3 illustrates a more detailed view of a user interface of a network application, showing an advertisement in a network application, as well as how clicking on or activating the in-game advertisement can lead to a modification of the items or attributes of a player character in a network application.

FIG. 4 illustrates another type of user interface, indicating how clicking on or activating an out-of-game advertisement can lead to a modification of the items or attributes of a player character in a network application.

FIG. 5 illustrates another type of user interface, indicating how purchasing a product and entering an accompanying code in a form can lead to a modification of the items or attributes of a player character in a network application.

FIG. 6 illustrates another type of user interface, indicating how clicking on or activating an item of a first player character can lead to a modification of the items or attributes of a second player character in a network application.

FIG. 7 is a flowchart of a method for advertising within a network application.

FIG. 8 is a modular diagram of a system for advertising within a network application.

FIG. 9 illustrates transformation of data from being in a data structure form representative of advertised products or services to being in a data structure form representative of items and attributes of a character and associated inventory. FIG. 9 also illustrates a subsequent transformation of data from being in a data structure form representative of items and attributes of a character and associated inventory to being in a data structure form representative of expired items and attributes.

FIG. 10 illustrates a set of non-linear or multi-path choices in which players may complete quests or tasks, as well as a countdown timer.

FIG. 11 illustrates a user interface showing a scrolling report of task performance and completion.

Like reference numerals refer to like elements throughout.

### DETAILED DESCRIPTION

The environment of the described systems and methods is initially described, followed by particular implementations.

A network application is provided that serves as an adjunct to an online simulation, affording significant additional and complementary functionality. Prior systems have not linked two game environments in this way. In one implementation, the network application is a web-based application that enables a user to control aspects of a character in an online simulation, i.e., a simulated world, e.g., a massively multiplayer online (MMO) game. For example, the network application may enable a user to control an “alter ego” of a character in the MMO. In this description, the online simulation is generally an MMO, and is often referred to as such, though non-MMO online simulations may also be employed. Moreover, for exemplary purposes, a common MMO implementation described here is that of a super hero MMO in which the related network application allows users to play within the context of a “secret identity” of the super hero.

A server computer system in conjunction with one or more client computer systems provide the MMO that has a given genre or theme where users or players create and control characters (“player characters” or just “characters”). The player characters interact with one another and with computer-controlled characters, the latter generally termed non-player characters (NPC's). Player characters are under player control and so act according to player instructions. NPCs are generally controlled by the server computer system.

The network application allows a player to explore and control their character in a different way, e.g., via an alter ego or a related character. As an example, in an MMO with a super hero theme, the network application may allow the player to access a “secret identity” of the action hero, performing acts in the life of the super hero when he or she is not in the super hero guise. The secret identity may have statistical attributes and a level as is conventional, and the same may be separate or may be linked with the same in the online simulation. In one implementation, the MMO and network application characters may only be separated by a predetermined number of levels. The acts that can be performed by the secret identity character may include not only trading, crafting, buying, and selling, but also taking parts in quests and performing tasks. The degree to which the network application may partake of such functionality may depend on level, subscription status, or the like. Quests and tasks may be performed using a text interface or through a low-fidelity graphical interface. Of course, full fidelity graphics may be employed where feasible. Accordingly, the network application can be accessed from one or more of various types of network-enabled platforms, such as a computer system (notebook or desktop), a mobile phone, a game system (console or portable), or a PDA. The network application can then provide appropriate interfaces (e.g., different GUI's) for the compatible platforms.

As may be seen, such a system is well-suited to certain genres, e.g., where an MMO character has an alter ego such as a secret identity, the secret identity being playable via the network application. However, one can easily imagine other genres, such as where a character has a pet, minion, child, or other related character which may benefit from web-accessible functionality. The roles defined above are not intended to be limiting: super hero acts may also be performed in the network application and conversely the secret identity may be controlled in the MMO. Generally, however, the network application may be especially useful for use with “alter ego” or similar roles.

Players may register to use the network application in a way similar to registration for social networking sites. Various information may be provided, e.g., to define a profile, and in the implementation above a secret identity may be created. A field may be provided where a link is made with an existing super hero identity, if one exists. In some cases, the secret identity may have no corresponding super hero. A section may also be provided where the player's mobile phone number is provided, in order to allow the player to receive optional alerts about events happening in-game. Such alerts allow the network application and MMO to take on aspects of an Alternate Reality game. In the same way, RSS feeds may be set up to communicate information about events, character leveling, character achievements, or the like.

The network application allows a player to view and control the status and activity of the character and related characters, e.g., staff or employees, while the user is not actively using the character, e.g., not logged into the the MMO (of course, the network application may also be accessed while the user is logged into the MMO). For example, the player character may have a job that the same goes to each day while not adventuring or fighting crime as a super hero. The player can view how the player character's job is progressing, select activities, and interact with co-worker NPC's or employees. Not only does such a system allow a character to play the same character (or related characters) across two different presentations, but the game environment may be configured such that a player is required to play both sides in order to fully experience all the content in the game.

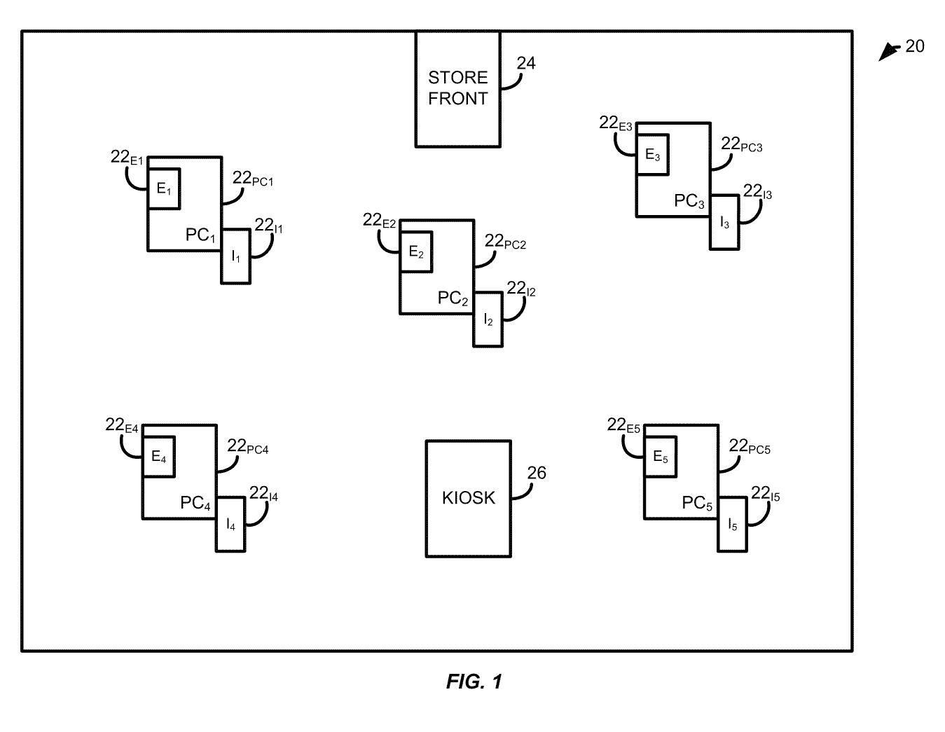

Referring to FIG. 1, a user interface (UI) 20 is displayed that portrays a multiplayer setting for an online MMO, or which may also represent a network application, e.g., a network game or the like. In the UI 20, a number of player characters 22_{PC1}-22_{PC5} are shown. Each player character 22_{PCi} represents a character entity that is controlled by a player or user within an environment. Typical ways of controlling a player character may include keyboard and/or mouse commands. Joysticks may also be employed, especially within the setting of console gaming.

Player characters within the environment typically interact with each other and with computer-controlled non-player characters. Player characters may also interact with the environment itself. Player characters may further act as a group to accomplish a common objective, e.g., to accomplish a particular quest, task, battle, and so on.

Each player character may have a stock of items to assist them in accomplishing tasks or goals, which are shown in FIG. 1 as player character inventories 22_{I1}-22_{I5}. An inventory may include weapons, food, potions, shields, armor or the like. For a player character to use an item in the inventory, in many cases, the same must be “equipped”. Equipped items are shown in FIG. 1 by elements 22_{E1}-22_{E5}, and may be thought of as those items that the player character is wearing, has in-hand, or otherwise has quick access to.

As noted above, player characters can interact with their environment. Two exemplary indicators of this are shown in FIG. 1, which are especially pertinent to the system and method for advertising. First, a store 24 is shown. In such a store, a player character may enter, purchase goods, sell goods, or conduct any number of other such transactions. Similarly, a kiosk 26 is shown, with which a player character may interact. A store generally allows entry of a player character, while a kiosk is generally a structure that a player character may access but not enter. While the system and method are described here as pertaining to advertising, and thus kiosks and stores are exemplified, numerous other variations and expansions will be apparent. That is, the system and method can be employed for objects other than advertising, and conversely, when employed in advertising, the same may be portrayed on virtually any feature of the environment.

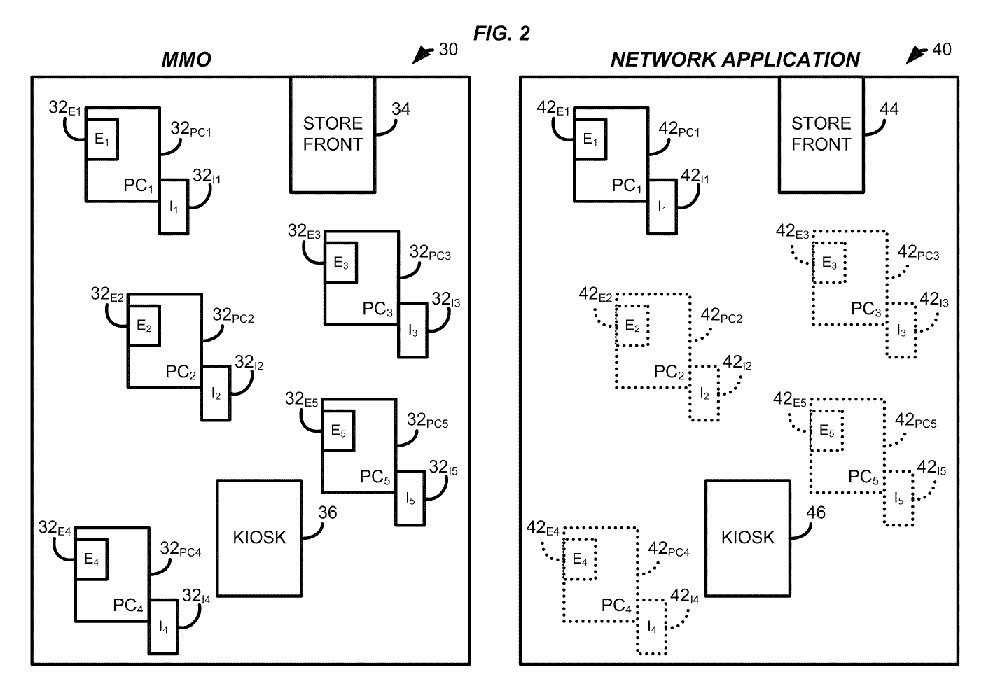

FIG. 2 shows side-by-side exemplary user interfaces 30 and 40 of an online MMO and a network application, respectively. A number of player characters 32_{PC1}-32_{PC5} are shown in the UI of the online MMO 30, and a number of player characters 42_{PC1}-42_{PC5} are shown in the UI of the network application 40. As in the UI 20 above, the player characters 32_{PC1}-32_{PC5} in the UI 30 generally have inventories 32_{I1}-32_{I5} as well as equipped items 32_{E1}-32_{E5}, respectively. The UI 30 also includes a store 34 and a kiosk 36.

Similarly, the player characters 42_{PC1}-42_{PC5} in the UI 40 have inventories 42_{I1}-42_{I5} and equipped items 42_{E1}-42_{E5}, respectively. The UI 40 also includes a store 44 and a kiosk 46. In some implementations, a player character need not have both a set of equipped items and an inventory: one alone may suffice in such cases.

The UIs 30 and 40 are generally not displayed at the same time (though in some implementations a dual-UI design may be employed). A user may operate and control one or more characters in the online MMO 30, and may also operate and control one or more characters in the network application 40. For example, a user may use the online MMO when they are at their own computer (with the MMO client loaded), while the network application may be accessed whenever the user is at any network-accessible computer. In one implementation, the player character in each represents the same player character, i.e., 32_{PC1} represents the same character as 42_{PC1}, just in another guise. For example, the online MMO may have a superhero or action hero theme, and the network application may be a way to play an “alter ego” or “secret identity” of the super or action hero. In other cases, the network application may allow a convenient and separate forum for trade or crafting skills. The inventory and/or equipped items of the player character 32_{PC1} may be the same or different as that of player character 42_{PC1}, or some items and statistics may be the same and others different. The use or existence of one item, e.g., in the network application, may augment or inhibit the power (or other statistic) of another, e.g., in the online simulation, or vice-versa. The network application may also provide a way for a user to perform various administrative tasks related to their player characters.

The network application may be accessed by separate groups of users and player characters divided into separate servers, or alternatively all players in the game may use the network application on one server as a common area for trade, communication, or the like. Such communication may be by way of email, chat, instant messaging, or the like.

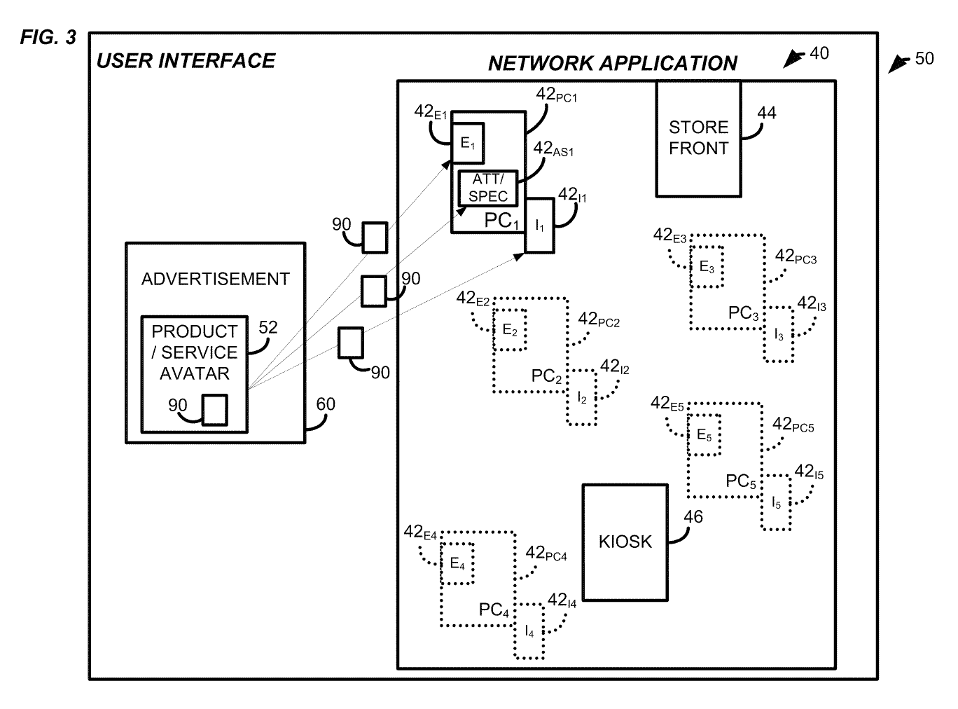

FIG. 3 illustrates in a graphical way the operation of the system and method for advertising. A user interface 50 is shown, which may include, e.g., the UI of a network application 40 (see also FIG. 2). As in FIG. 2, a number of player characters 42_{PC1}-42_{PC5} in the UI 40 are shown with inventories 42_{I1}-42_{I5} as well as with equipped items 42_{E1}-42_{E5}, respectively. Elements with like reference numerals are as described above.

An advertisement 60 may be displayed on the user interface 50 along with the UI 40 for the network application. The advertisement 60 may include a description 52 of a product or service along with a visualization 90 of the same, which is often constructed of an image, application, or the like, commonly employing technologies so as to enhance the visual impact. The advertisement 60 may be displayed when a web page that references the advertisement, e.g., a web page associated with the network application, is loaded into a web browser. The advertisement 60 may be in a number of forms, including a banner advertisement, a pop-up advertisement, a hover advertisement, a live banner or advertisement, or the like. In “live” advertisements, advertisements are provided that include content that changes in real time. Advertisements may be delivered from a central advertisement server, or may be provided from individual advertisers.

If the user is interested in the product or service displayed in the advertisement 60, then the user may click on or activate the ad. In so doing, the user may click through to a more detailed advertisement, or may otherwise sign-up for and receive additional information about how to obtain the product or service. In addition, with the system and method for advertising described, the player character 42_{PC1} may obtain (or obtain access to) a virtual copy of the product, or may have their character attributes modified in accordance with the use of the product or service. This action is indicated in FIG. 3 by the items 90 traversing (see arrows) into the player character 42_{PC1}'s inventory, equipped items area, or onto a player character's attributes or statistics 42_{AS1}. That is, where the product or service enhances a character's attributes or other statistics, the same may not be considered to enter an inventory, but rather to affect a player character's attributes directly.

As an example of a product, an advertisement of a car may be displayed to the user on the UI. If the user clicks on the advertisement, the user may receive additional information about the car. In addition, a player character associated with the user may receive a virtual car as a vehicle for their use in the network application. Use of this vehicle may lessen the time required to complete certain tasks, may raise the standing of the player character in the community, or the like. In some cases, the car or other item may “expire” after a given time, so that the user (or player character) is required to obtain another car, e.g., by clicking on another advertisement or the like.

As noted, a store 44 or kiosk 46 (or any other such location) may provide a locus where a number of products or services may be advertised, and thus a number of different products or services may be obtained by player characters. Correspondingly, users may obtain information about the number of actual products or services. As an example, a mobile phone kiosk may be provided where a user may view many advertisements and obtain a virtual phone for their player character.

As another example of a product, in this case a consumable product, an advertisement may be displayed for a health food. By clicking on the advertisement, the player character may receive an amount of a virtual health food in their inventory. When the player character consumes the health food, their attributes are enhanced for a certain period of time. Of course, alcohol or the like may also be consumed, which may lead to a decrease in certain user attributes.

As an example of a service, an advertisement may be displayed for a weight training service. By clicking on the advertisement, the player character may receive an increase in physical stamina, endurance, strength, or other physical attribute. As with food items, the attributes or statistics may be enhanced for only a predetermined period of time or may alternatively be permanent.

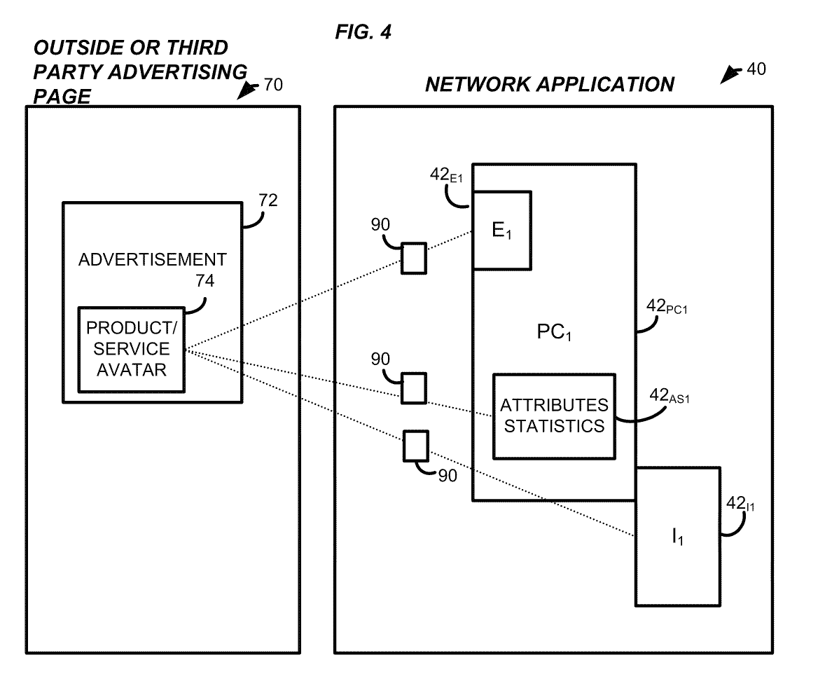

Referring to FIG. 4, an advertisement 72 may be displayed that is not associated specifically with the network application UI 40. That is, the advertisement may appear on a third-party or other web page or site 70 outside the UI 40 of the network application. As above, the advertisement 72 may be a banner advertisement, a pop-up advertisement, a hover advertisement, a live banner or advertisement, or the like, and may include a description 74 of a product or service. Other reference numerals in FIG. 4 refer to like elements described in FIG. 3.

If the user is interested in the product or service displayed by the advertisement 72, then the user may click on or activate the ad. In so doing, the user may click through to a more detailed advertisement, or may otherwise sign-up for and receive additional information about how to obtain the product or service. By clicking or activating the advertisement 72 on the third party or outside page 70, the page 70 transmits a message to a server associated with the network application 40. The message indicates that the user's player character 42_{PC1} may obtain access to a virtual copy of the product or may have their character attributes altered in accordance with the use of the product or service. This action is indicated in FIG. 4 by the items 90 traversing into (see arrows) the player character 42_{PC1}'s inventory, equipped items area, or onto the player character's attributes or statistics 42_{AS1}. As above, where the product or service enhances a character's attributes or other statistics, the same may not be considered to enter an inventory, but rather to affect a player directly.

As the page 70 is not associated with the network application, the user may be requested to enter appropriate additional information to identify the game, server, and character which should receive the item or attribute modification.

As an example of a product, a user may have navigated to a website advertising mobile phones. An advertisement on the site may include a button such as “SEND PRODUCT TO CHARACTER” and by clicking the button the user may begin the process of causing a virtual copy of the product or service to be accessible to a player character in an MMO, network application, or the like. A form may be displayed requesting information about which game the user plays, which server, and their character name.

Of course, not all products may be applicable to all games. In the implementation of the system and method of FIG. 3, the network application itself may self-select which products may pertain to player characters, e.g., via a look-up list of types of products. In the implementation of FIG. 4, game identification information may be requested from players as noted. Alternatively, if the system is made aware of which games are played by the user, some level of product or service suggestion may be accomplished. For example, if the system can be made aware that the user plays a superhero networked game, which takes place in an urban setting, advertisements for cars, mobile phones, clothes, or the like may be applicable. If the game has, e.g., a fantasy setting, some items and products may still pertain, though certain of the same may be translated into analogous products. For example, clicking on an advertisement for a sports nutrition supplement may cause a player character to receive a similar food supplement that increases strength or endurance. However, clicking on an advertisement for a new automobile may cause a player character in a fantasy game to receive a new mount for riding rather than an automobile, as the same may not be consistent with the other content in the game. In some cases, if the user clicks on the advertisement, the user may receive additional information about the product or service, and may place an order for the same, in addition to obtaining an item for their player character's use.

As above, use of the product or service may lessen the time required to complete certain tasks or may assist in other functions, and the same may “expire” after a given time, so that the user (or player character), is required to obtain another, e.g., by visiting a known location such as a store or kiosk.

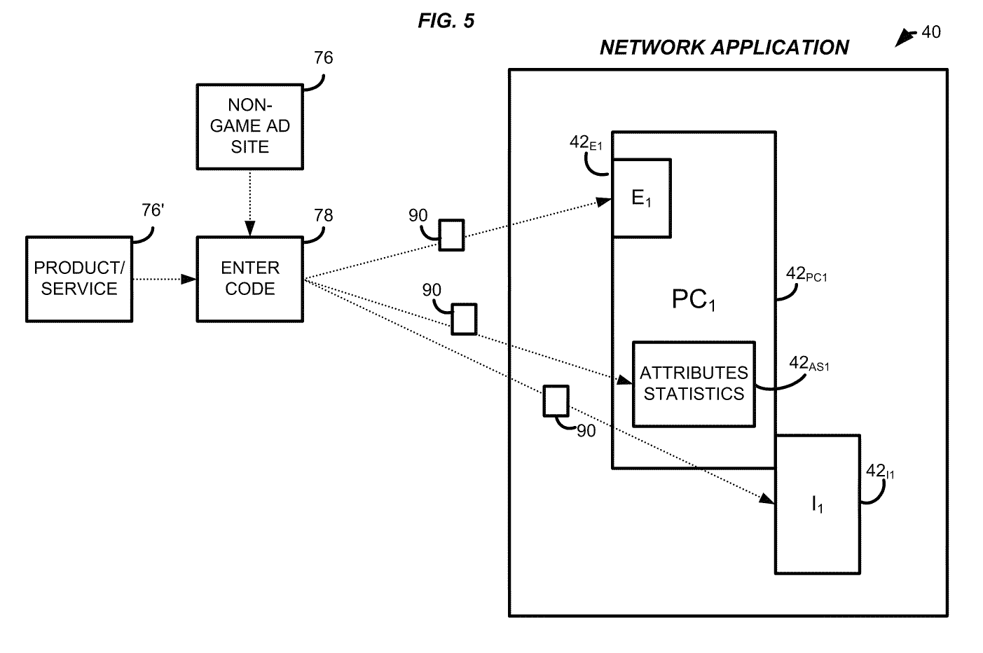

FIG. 5 illustrates another implementation of the system and method. Certain reference numerals in FIG. 5 refer to like elements described in FIGS. 3 and 4. In FIG. 5, a third party site 76 may act in a way similarly to the third party site in FIG. 4. However, in this case, the third party site 76 provides a code to the user upon some action, such as clicking an advertisement, clicking a button within the advertisement, ordering a product, entering information in a form, or the like. That is, following this action, the user receives the code. The code can be entered in a form 78 associated with or within the network application 40. Following the code entry, a player character associated with the user can obtain access to a virtual item corresponding to the product or service as noted above.

Alternatively, a user may have purchased a physical product or service 76′. In this case, the purchased product may be packaged with a code, or a code may be otherwise accessible upon purchasing or registering the product. However the code is obtained, a user may enter the code as above to enable their associated player character to obtain access to a virtual item. Steps similar to the above-noted steps of character and game identification may be required. Entering the code causes a virtual item, corresponding to the advertisement 90 or purchased product, to be made accessible to the player character 42_{PCi}, and the same may affect the inventory 42_{I1}, the equipped items 42_{E1}, or the attributes and statistics 42_{AS1}.

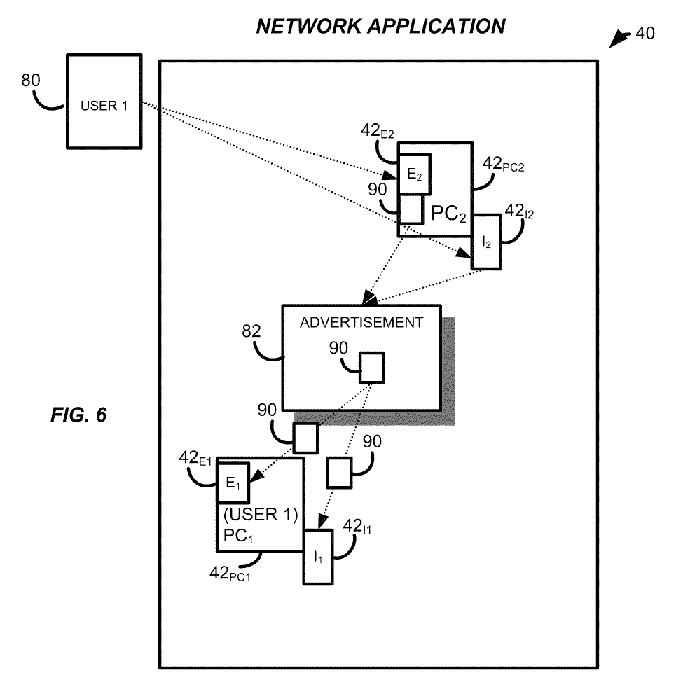

FIG. 6 indicates yet another way in which products or services may be advertised and corresponding virtual items delivered to player characters. In this implementation, a user may click directly on a player character's inventory, equipped items, or attributes/statistics, in order to obtain a similar item or attribute modification for their own player character. In particular, a user 80 may operate and control a player character 42_{PC1} on a UI 40 of a network application. The user 80 may view another player character 42_{PC2} on another portion of the UI 40. The player character 42_{PC2} may be seen to have an item that the user 80 is interested in, which the user would like to obtain for their own player character 42_{PC1}. In some cases the user 80 may view such items directly on the player character 42_{PC2}. In another case, the user 80 performs an inspection function in order to see the items, e.g., as part of an inventory. In yet another case, the user 80 may view the inventory or equipped items via a separate application or website, such as one that catalogs and displays the inventory of all characters in the game.

When the user 80 clicks on an item, or a particular portion of an item, either on the player character or a separate site, an advertisement 82 may be caused to appear, such as via a hover advertisement on top of the network application UI 40 or alternatively on top of the separate site. The advertisement 82 often includes an image 90 of the advertised product or service. By clicking on the item and causing the advertisement to appear, or by clicking on a portion of the advertisement, or alternatively by a related action, an item related to or associated with the advertised product or service may be made accessible to the player character 42_{PC1} in the same ways as noted above.

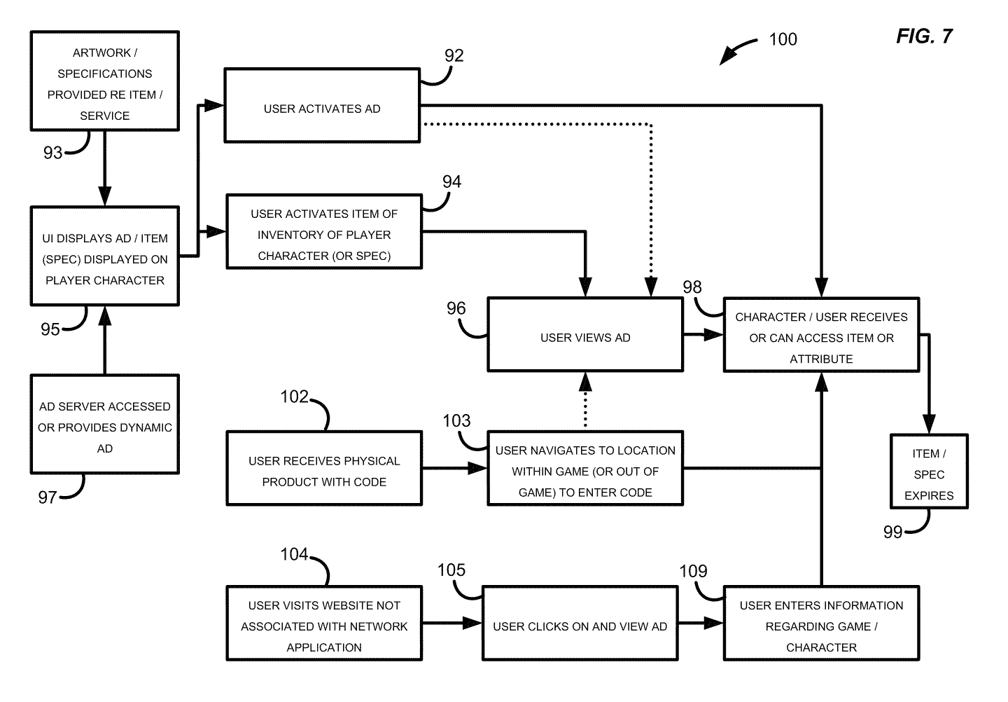

FIG. 7 is a flowchart 100 of the method. In one potential first step of the method, various artwork and other specifications (e.g., frequency of display) pertaining to an advertisement are provided to a game server and/or to a network application server (step 93). The advertisement generally pertains to a product or service that can be provided as a virtual item to a player character in a video game, e.g., to enhance the ability of the player character to perform a task or function. For example, a mobile phone item may be provided to enhance a player character's ability to communicate. A food item may be provided to enhance the player character's strength or stamina Numerous other examples will also be understood given this description. A UI provided by the game server or network application may then display the advertisement (step 95). In an alternative implementation, the item or service may have already been provided to another player character, and a user may click on or activate the item (or attribute modification) as displayed on the other player character.

It is noted that, in lieu of being provided well in advance, the advertisement may also be provided in a dynamic or “live” basis, either as retrieved by the game or network server from a store of such advertisements, or as provided by a separate advertising server (step 97).

Following display, a user or player may click on or activate an advertisement (step 92). This step is pertinent in situations where the user has an advertisement displayed on their UI, such as where the advertisement forms a portion of a network application UI. In such cases, the system already has stored in a memory location an identifier of the network application and character identifier. That is, since the user is currently playing the game, the system can be made aware of the identity of the game as well as the identity of the character currently being played. Having viewed the advertisement, the UI can send a message to the game engine indicating that access to an item corresponding to the advertised product should be granted. The user's player character may then access an item corresponding to the advertisement (step 98).

In an alternative step, a user may activate or click on certain items of a player character's inventory or on an item the player character has equipped (step 94). In this case, an advertisement may be subsequently displayed for viewing by the user (step 96) giving additional details about the product clicked on. Generally not all items a player character possesses will be clickable, since not all items will have advertisements pertaining to them. However, certain items may be especially likely to have advertisements associated, such as electronic gear, clothing, and vehicles.

A user may also click on an attribute of a player character, the attribute associated with a service. The attribute may be displayed, e.g., in a list of statistics for the player character. For such “clickable” services, the UI may indicate that a player character has had their strength (or other attribute) modified by virtue of, e.g., a weight-training service. By clicking on an indicator of the modified attribute, the user may be shown an advertisement. Once the advertisement has been displayed, the user's player character may then access the item or attribute corresponding to the advertisement (step 98), i.e., the user's player character may receive the benefit of the weight-training.

It is noted in connection with this step, as well as any of the others, that clicking on an advertisement may well lead to numerous other opportunities for the user. For example, the user may be directed to a manufacturer web site, may be enabled to email or notify others about the product or service, or may take innumerable other steps.

In another implementation, a user may purchase or otherwise receive a product or service with an accompanying code (step 102). In this case, the user may then navigate to a specified form page (or equivalent) of the network application or online MMO (or even a location external to these) and enter the code (step 103) in order to receive a virtual item (step 98) corresponding to the product or service. Upon entering the code, some implementations may display an advertisement (step 96) corresponding to the product or service to provide greater visibility and information.

In yet another implementation, a user may visit a third-party or unrelated website, i.e., one unrelated to the network application or online MMO (step 104). In so doing, the user may click on and view any of the types of advertisements described above (step 105). In this case, the system is generally unaware of the network application or online MMO the user plays, and even more may be unaware of what player character for whom access should be enabled to the corresponding item. For these reasons, a form may be displayed whereby a user may enter information about the game played, server information if necessary, and the player character to whom the item should be given (step 109). Once this information is provided, the third party site, or alternatively another site to which the user was directed following advertisement activation, may transmit a message to the server on which the network application or online MMO operates. The message may indicate the player character to receive the item, as well as any other pertinent information. Of course, in some cases this information may be retrieved from the user's computer system, although in many cases privacy concerns, or a lack of sufficient privileges, may prevent such information from being obtained. Following the message, the item may then be accessed by the player character (step 98).

As will be understood, combinations of the above may also be employed. For example, following a visit by a user to an unrelated website, and subsequent viewing of an advertisement, a code may be provided to the user, and the method may again begin with the code-entering step (step 103), with or without another viewing of the ad.

In many implementations, following the accessing or the opportunity to access the item or attribute modification, the same may expire (step 99). The item may simply disappear, may be inaccessible, may provide no further benefit or attribute modification, or the like.

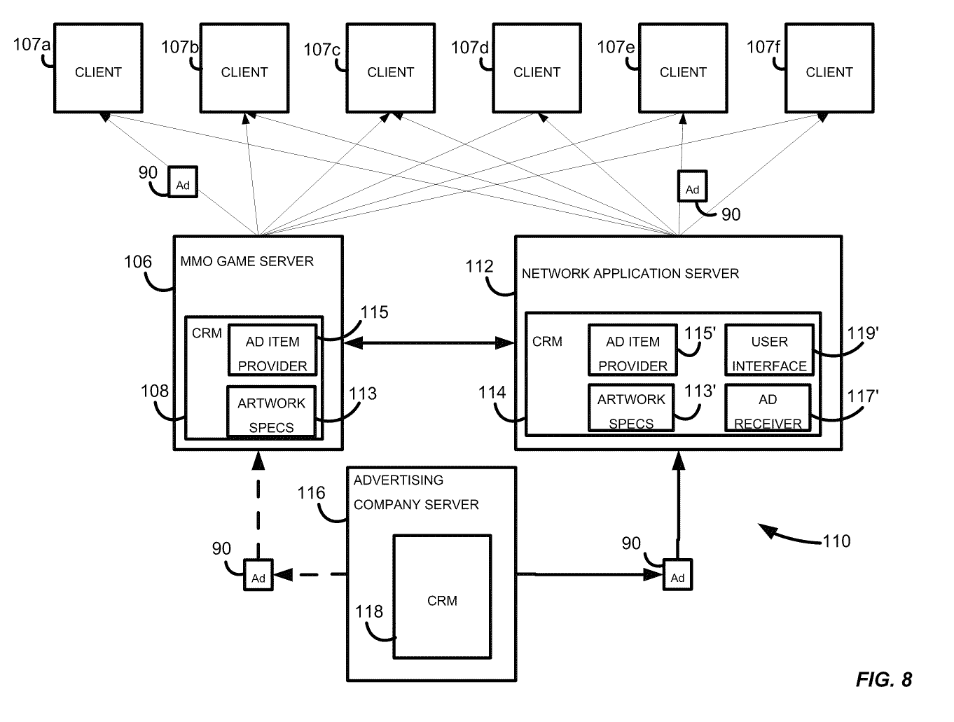

FIG. 8 illustrates a modular depiction of a system 110 for advertising using a network application or online MMO. An MMO game server 106 includes a computer-readable medium 108 and the combination operates the online MMO described above. The computer-readable medium 108 may include various artwork and specifications 113, not only of the game but also of art provided by an advertiser or other entity, the same being used to advertise a product or service. An advertisement item provider module 115 may be employed to provide items to player characters, according to user activation of displayed ads. The advertisement item provider module 115 may direct a modification of a data structure corresponding to a player character's inventory or the like to accomplish this function.

In one implementation, a network application runs alongside of the online MMO, and the same runs on a network application server 112 that also includes a computer-readable medium 114 on which may be stored artwork and specifications 113′. The computer-readable medium 114 may also include an advertisement receiver module 117 to receive advertisements from an advertising server 116 as well as a UI module 119 to provide display functionality about such advertisements, e.g., how the same should be displayed and the like. The UI module 119 may also be the same module that renders the game itself. The network application server may also include an advertisement item provider module 115′ for, upon receipt of a user activation of an advertisement (or user entry of a code), providing an item or attribute or service (corresponding to the advertisement) to a player character associated with the user. The network application provides complementary functionality to the online MMO, as described above and in the provisional application incorporated by reference above. While not shown, the MMO game server 106 may also include a UI module and an advertisement receiver module.

The advertising server 116 including a computer-readable medium 118 may be accessed by the network application server, and/or by the MMO game server, to retrieve and display advertisements 90 during a user's gameplay. During gameplay of the online MMO, the game server 106 may provide advertisements 90 (received at some prior time from the advertising company server) to clients 107a-107f. Similarly, during gameplay of the network application, the network application server may provide advertisements 90 to the same clients 107a-107f. As noted above, the advertisements may be provided in advance, may be provided on a dynamic basis, or may be provided using any other advertising functionality as appropriate. Upon user activation of an advertisement (or item on another player character), the user's player character may receive an item, or access to an item, corresponding to the advertisement as described above.

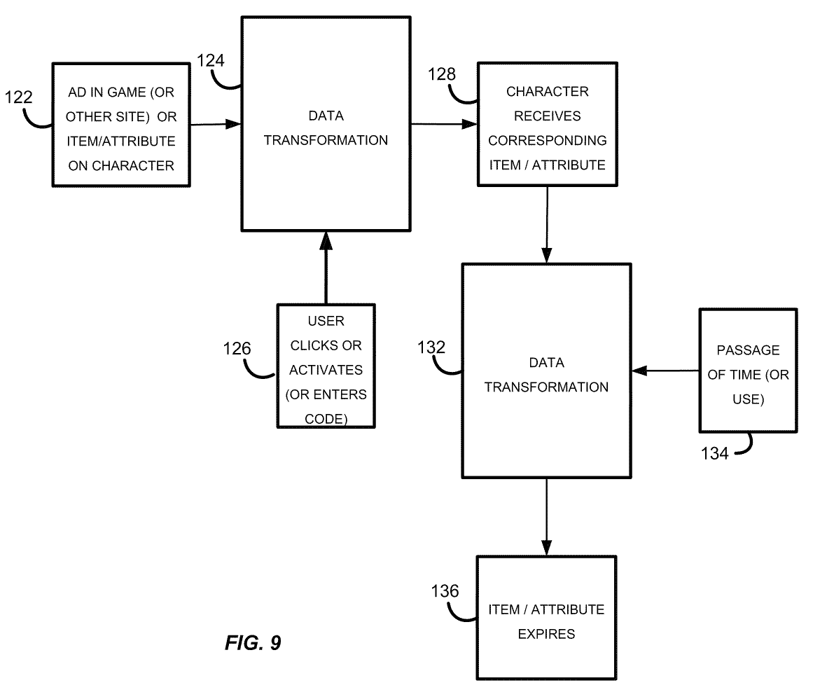

FIG. 9 illustrates how data may be transformed within the system and method. This data generally represents data structures stored in computer-readable media which in turn represent products or services to be advertised, as well as items or attributes that may be associated with a player character in a network application or in an online MMO. A first data structure 122 is an advertisement in a game for a product or service or an item or attribute associated with a player character in the game. The first data structure may also be an advertisement in a third party site, or a code that, upon entry in a form, results in an item, corresponding to the product or service, being made accessible by the player character. Upon a user clicking on or activating the advertisement, or entering the code (step 126), the advertisement data is transformed (data transformation 124) into a data structure 128 representing an item accessible by a player character and corresponding to the advertised product or service.

The data structure 128 may further be transformed (data transformation 132) into a data structure 136 representing an expired item or attribute, this transformation caused by a passage of time or by a cumulative amount of use (step 134). The data transformation 132 may be accomplished by the setting of a flag, or via any other such data transformation technique.

It is noted that the servers (and/or modules) above may be combined in any number of ways, e.g., the MMO game server and the network application server may operate on the same physical machine. Moreover, an advertising server need not be in constant communication with the game and network application servers. Rather, the same may be just in periodic communication, downloading advertisements on a daily or weekly basis, along with metadata indicating the frequency with which the advertisements should be displayed, as well as artwork and specifications about virtual items and attribute modifications that may be associated with the product or service.

Other variations and implementations are also possible. For example, implementations could be developed for providing advertising in other online services besides games, such as chat, telephony, or video conferencing, in which case modifications of the virtual products, e.g., coupons or trial samples, may be provided to users. In educational embodiments, the system and method may be employed to provide rewards for students who solve problems first, who are particularly proficient, or who make significant progress. A group within a game, such as a guild or the like, may be set up and the same may be configured to mutually benefit from the responses of their members to advertisements. Alternatively, the same may mutually respond to and benefit from a group response to an advertisement. While the above description has discussed (in some implementations) interactions between two users, three or more users may also have a group interaction. The game application, the network server application, any associated advertising application, or the like, may be disposed on the same or on different servers as appropriate.

As noted above, the use of a network application linked to an online simulation may also provide for additional functionality beyond advertising. These additional functions are described below. A first additional function relates broadly to systems and methods for performing quests or tasks that incorporate non-linear, variable, or multi-path elements. A second additional function relates broadly to social networking features.

With regard to the first additional function, it is initially noted that the network application may be primarily text-based and may generally provide tasks for a character to perform. For example, an NPC may provide a task for the subject player or player character. In the text-based screen showing the task, an icon for both the NPC and the player character may be displayed. The task may require a generally predetermined amount of time, depending on how the player chooses to perform the task. If the task is taken, the time may be deducted from an overall amount of time allotted for that character per day. For example, each character may receive eight hours of time to complete tasks for each calendar day of “real” time. A value of “time remaining” for the character may be displayed by a countdown clock.

Tasks are assignments or requests that frame a series of activities. They are made up of a series of steps, and one or more steps, or all steps, may require the player to make one or more choices about how to perform the task. By selecting different options for each step, the player controls the total amount of time the task will take to complete. Hence, players may advantageously budget their activities and choose what they want their network application character, e.g., secret identity, to accomplish in a given day.

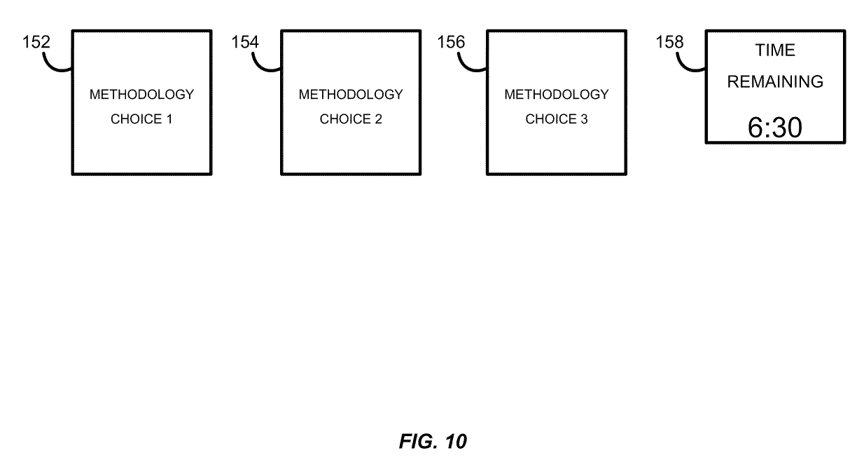

For example, referring to the FIG. 10, three methodology choices 152-156 are provided for a given task. A time remaining in a character's day is also shown by countdown timer 158. Each methodology task may affect the steps performed by a player in completing the tasks. For example, methodology choice 1 may provide the player with a series of choices, each choice constituting a different way to perform a given task. For example, the task may be to compile material for a news story. One methodology choice may be to interview witnesses. Another may be to travel to a library to obtain background for the story. Methodology choice 2 may provide choices about the way in which the material is compiled: one way is to be especially thorough, and another may be to take a “short cut” or “cheat”. The short cut or cheat is faster, but less information is obtained. In addition, the short cut may provide fewer opportunities to communicate with other characters on the street or in other locations. In another implementation, the cheat provides a risk/reward choice—if the user selects the cheat, the cheat may provide a chance for a better result if successful (higher quality or lower time) but also provide a worse result if the cheat fails. In the superhero/secret identity context, one special type of cheat could be for the secret identity character to use one of the corresponding superhero's powers. In that case, the network application character would again be utilizing functionality from the simulation. Methodology choice 3 may pertain to a final step in the task, e.g., to write the news story or to have an assistant write it. The choice is up to the player, but the consequences of the choice may incorporate a random element. For example, a short cut may not work, and the player character may have to retrace their steps and perform the step the “long way”. Alternatively, the steps selected may provide access to different later choices, providing a multi-path sequence.

Choice of a particular step may lead to the character encountering an NPC, including high profile or iconic NPCs, along the way. These encounters increase the character's contacts list, and may lead to quests or tasks that are otherwise inaccessible. Such encounters are generally with NPCs; however, in some implementations, it may be possible for a character to encounter another player character, e.g., if a player character always performs a particular function for the subject player character, there may be configured a facility whereby that player character can perform the same function on behalf of the subject player character during a task.

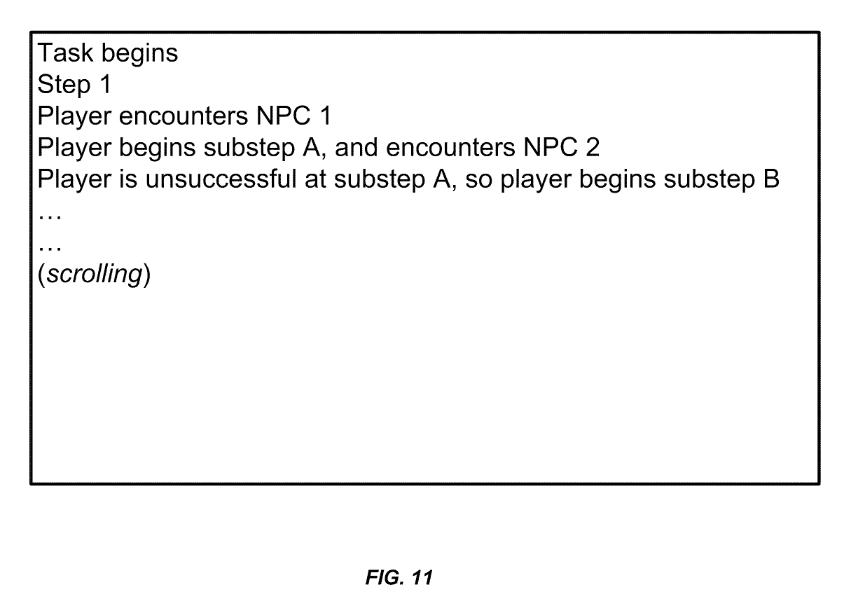

As time is consumed performing the steps of the task, the time may be seen to count down on the clock. In one implementation, the time counts down in “real time”, such that if a task takes 1 hour, the player must wait an hour before starting the next task (although in some cases a task may be interrupted in order to allow a different task to proceed). Alternatively, the time count down may be accelerated so that, e.g., a minute of “game time” lasts only a second in “real time”. As time counts down, the player may view a scrolling list of actions that are occurring during performance of the step and ultimately, task (see, e.g., FIG. 11). In some implementations, players and characters may be allowed to exceed their predetermined allotment of time for the day, but may then incur a small penalty or the like. Use of certain substances, such as energy drinks, may allow a player and character to receive more time in a workday.

Certain tasks, as well as steps within tasks, and substeps within steps, may incorporate a degree of random variation. For example, a player may choose to perform a step using a shortcut, but the shortcut may not succeed. Moreover, a series of random events may occur that can increase or decrease the time taken. In addition, the player can earn optional rewards through these events. In this way, while it may be generally known how long a task may take to perform, the actual duration may only be known after all steps or substeps incorporating random variations are concluded.

While many tasks require in-game time to complete, in some implementations certain tasks may be instant. For example, production tasks, which include making a recipe or creating a dossier, may not count against the total time available in a day.

“World events” may occur which affect all players at the same time, and the same may affect tasks or steps that are currently being performed. For example, a villain may attack a given city, and the same may disrupt all player characters that are currently performing tasks in that city, e.g., causing delays in transportation. In some cases, some or all characters may be offered the opportunity to take part in “missions” related to that world event. In one implementation, some world events are events that occur in the network application environment because of actions or events in the corresponding MMO or online simulation. For example, if a battle between a hero and villain in the MMO destroys a building or structure, e.g., a bridge, that structure may not be available to the secret identity characters for a period of time as well and could affect the completion of tasks. For example, longer travel times may ensue due to the necessity of traveling around the destroyed bridge.

As noted above, another aspect of the use of a linked network application and online simulation is in the context of social networking functionality. In this aspect, the network application provides significant social networking functionality, similar to that provided by popular social networking sites or services, such as contacts, friends, messaging, profiles, blogs.

Using the network application presented here, social networking conventions may be leveraged to not only provide information about player characters but also to provide a way to play the adjunct game, i.e., the network application. The two games, the online simulation and the network application, may run in parallel but may operate asynchronously. For example, mail sent between the two games may not be delivered instantaneously but may rather include a built-in delay to control the interaction between the online simulation and the network application.

The social networking features may be accessed even by those with no MMO game client or those to whom the MMO functionality is incidental. That is, some users may wish to simply gain access to the network application as a way to socialize with their game-playing friends. Moreover, while the use of the network application has been mentioned above to provide a way to operate a secret identity, where the corresponding super hero is a character in the online simulation or MMO, no such use is required. The network application may simply be a way to manipulate and/or enhance one's online simulation character, e.g., by making or modifying items (e.g., a crafting interface, where contacts listed as part of the social network may be employed as resources to craft game items that may be used in the network application, online simulation, or both), communicating with other characters, using the character in the network application to buy and sell items (e.g., an auction interface), and the like. The network-accessibility allows these aspects of the game to be played from any online computer, as well as from mobile devices and other computing devices. Moreover, use of the network application may provide an introduction to the game for new players. Accumulation of goods on the network application may lead players to join the online simulation as well, since certain of the goods may be transferable. In another implementation, the network application provides access to a common user avatar or profile that can be used in multiple online games. In this case, the relationship of the network application to online games or simulations is one-to-many, rather than one-to-one. For an MMO with multiple instances or servers (which are often isolated from one another), the network application can provide a central area where players on different servers can interact. Alternatively, the network application may be used to access a user profile and environment that is independent of a particular game but can be used for a community related to one or more games or game services.

Other features in social networks may also be employed. For example, players can communicate via email, messaging, and various supported voice chat clients with other players on the web or across into the game. In the super hero and secret identity context, players can view other players' secret identity characters, super hero characters, leader boards, and any other exposed information via the network application. In some implementations, if a player has notified another player of their secret identity and their corresponding super hero (MMO) identity, that information may be displayed in the player's view as well. A separate “player” site may be provided whereby a player can view all of his or her MMO characters and associated secret identities in a single webpage. From within the network application (e.g., the secret identity social networking site), a player may view the associated action hero, e.g., in a “paper doll” format.

Other social networking conventions may also be employed. For example, a character may have an associated contacts list, which is a list of characters that the subject character has become acquainted with through their game play. These characters may be NPCs, including iconic NPCs, other player characters (in the particular implementation described, these may be secret identities or super heroes), or other such in-game characters. Characters may be added to a contacts list in a number of ways. In one implementation, characters are added whenever the subject character interacts with or otherwise encounters them, e.g., by speaking with the same during a task, by helping them in a task, or the like. A number of tasks may be provided via players checking their character's contacts list, e.g., a flashing contact icon may indicate that the given contact has a task for the subject player character to perform.

Distinct from the character contacts list, a player may have various friends lists, the same listing players that the user enjoys playing the game with, members of a league or guild, or the like. Other characters can be added to friends lists through, e.g., add or invite operations.

Characters may travel from one place to another by clicking on a point-of-interest in a user interface that portrays a map of available travel points. Such travel may be instantaneous or may use a portion of the time allotted in a day (variable or predefined). Once at a given location, a “job” window may be displayed exhibiting tasks that may be performed by the character in that location. The available tasks may be based on what contacts are in the character's contacts list, what tasks have already been performed, or on other such factors.

One implementation includes one or more programmable processors and corresponding computer system components to store and execute computer instructions, such as to provide the server and client systems to operate and interact in the online game environment and network application, as well as to monitor and control the data and interaction of NPCs and player characters in the same. The server system may employ a database component, e.g., MySQL, running on an operating system, e.g., Linux. The client system may be a personal computer or other type of computing device, including a game console such as the Sony PlayStation 3® game console. The client system may also be any of the variety mentioned above, including mobile phones.

Additional variations and implementations are also possible. For example, the development system could be applied to other types of games (e.g., fantasy or science fiction). The system may be applied to a network application that serves as an adjunct to any other sort of client-server system. The online simulation and the network application may each be web-based. In another implementation, a home network provides an environment similar to an MMO and the network application may allow a user to access and modify components in the home network from any network-accessible location. The network application can serve as the site for an online trading card game or other “side” game related to the networked game, the MMO, or both. Reward points may be provided that may be exchanged for goods and/or services within the game. These points may even be given to players for various conditions, for example: successful task or quest completion, length of subscription, account activity, or subscription renewal (in this way, players may be rewarded for re-subscribing). Accordingly, the scope of the invention is not limited only to the specific examples laid out herein.

1. A computer-readable medium, comprising instructions for causing a processor in an electronic device to perform a method of advertising a product or service, the method comprising:
a. displaying an advertisement for a product or service in a video game, the video game including one or more player characters operable by one or more users;
b. receiving a response from a user about the advertisement;
c. in response to the received response, modifying an attribute of a player character associated with the user, the modification relating to the advertisement, or allowing the player character to access a virtual item relating to the advertisement.

2. The medium of claim 1, wherein the video game is a network application.

3. The medium of claim 1, wherein the video game runs on a personal computer, a game console, a mobile phone, or a personal digital assistant.

4. The medium of claim 1, wherein the advertisement is selected from the group consisting of: a banner advertisement, an in-game advertisement, a clickable item of a player character's inventory, a clickable item of a player character's non-inventory items, and an advertisement displayed in an in-game store or kiosk.

5. The medium of claim 2, wherein the network application is associated with an online multiplayer game.

6. The medium of claim 5, wherein the network application is a web application.

7. The medium of claim 5, wherein the virtual item may be transferred from the network application to a player character in the online multiplayer game.

8. The medium of claim 1, wherein the advertisement includes an avatar of the product.

9. The medium of claim 2, wherein the advertisement is textual or low-fidelity.

10. The medium of claim 1, wherein the attribute or item expires after a predetermined period of time or after a predetermined amount of use.

11. The medium of claim 1, wherein, in the video game, a time required for a player character to complete a task or quest is at least partially related to the item or attribute.

12. A computer-readable medium, comprising instructions for causing a processor in an electronic device to perform a method of advertising a product or service, the method comprising:
a. displaying an advertisement for a product or service;
b. receiving a response from a player about the advertisement;
c. in response to the receiving, modifying an attribute of a player character in a video game or allowing a player character to access a virtual item in a video game, the video game including one or more player characters operable by one or more users.

13. The medium of claim 12, wherein the product or service is related to the attribute or item.

14. A computer-readable medium, comprising instructions for causing a processor in an electronic device to perform a method of advertising a product or service, the method comprising:
a. displaying an entry form on a user interface for a video game, the video game including a representation of a third party product or service;
b. receiving a code entered by a user in the entry form;
c. in response to the received code, modifying an attribute of a player character in a video game or allowing a player character to access a virtual item in a video game, the attribute modification or virtual item associated with the third party product or service, the video game including one or more player characters operable by one or more users.

15. The medium of claim 14, wherein the code is associated with the user purchase of the third party product or service.

16. The medium of claim 14, wherein the attribute modification further applies to a character in a corresponding online simulation, or wherein the virtual item may be controlled by a character in a corresponding online simulation.

17. A system for providing an item to a player character associated with a user of a multiplayer game implemented on a network application server, comprising:
a. an advertisement receiver module to receive an advertisement from an advertising server;
b. a user interface module to display the advertisement;
c. an advertisement item provider module to, upon user activation of the advertisement, make accessible a corresponding item to a player character associated with the user.

18. A system for providing an item to a player character associated with a user of a multiplayer game implemented on a network application server, comprising:
a. a user interface module to display an item or attribute modification on a first player character;
b. an advertisement item provider module to, upon user activation of the item or attribute modification, make accessible a corresponding item or attribute modification to a second player character, the second player character associated with the user.

19. The system of claim 18, wherein the user interface module is further configured to, upon the user activation, display an advertisement corresponding to the item or attribute modification.
